(19) United States
(12) Patent Application Publication
(10) Pub. No.: US 2007/0058660 A1
(43) Pub. Date: Mar. 15, 2007

(54) Wireless communication method and apparatus for controlling access to Aloha slots

(75) Inventors: Mohammed Sammour, Montreal (CA); Angelo A. Cuffaro, Laval (CA); Sudheer A. Grandhi, Mamaroneck, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/478,815

(22) Filed: Jun. 30, 2006

Related U.S. Application Data
(60) Provisional application No. 60/702,107, filed on Jul. 22, 2005.

(51) Int. Cl. H04L 12/413

(52) U.S. Cl. 370/445

(57) ABSTRACT

A method and apparatus for controlling access to Aloha slots are disclosed. An access point (AP) assigns at least one Aloha slot for a wireless transmit/receive unit (WTRU). The AP may assign the Aloha slot based on quality of service (QoS) policy, measurements of a predetermined metric, or combination of both. The metric may be the number of WTRUs assigned to each Aloha slot or a traffic load on each Aloha slot. The AP may also assign an Aloha slot over multiple superframes. The AP may restrict allowed access categories (ACs) in the Aloha slots. Alternatively, the AP may partition the Aloha slots into a plurality of groups and indicate an AC allowed in each group of Aloha slots. The AP may indicate an access period or frequency for each AC.

### CROSS REFERENCE TO RELATED APPLICATION

This application claims the benefit of U.S. provisional application No. 60/702,107 filed Jul. 22, 2005, which is incorporated by reference as if fully set forth.

### FIELD OF INVENTION

The present invention is related to wireless communication systems. More particularly, the present invention is related to a method and apparatus for controlling access to Aloha slots.

### BACKGROUND

Slotted Aloha is a synchronized protocol, having “slots” of equal-sized intervals of time. Transmissions are permitted only at the beginning of each slot and collision is immediately detected if two or more transmissions occur at the same time. When collision is detected, packets are retransmitted until transmission is successful.

With respect to an IEEE 802.11n proposal, a plurality of slots, (N slots), in each frame are available for making requests by a wireless transmit/receive unit (WTRU) as shown in FIG. 1. A WTRU selects one slot randomly from the N slots and sends a reservation request to an access point (AP) for transmission of data. The AP then sends a response for acknowledging the receipt of the request, and if appropriate, grants the WTRU the opportunity to send the data.

With respect to cellular systems, (e.g., the third generation partnership project (3GPP) wideband code division multiple access (WCDMA)), Slotted ALOHA is utilized as a random access technique. In accordance with 3GPP technical specification 25.211, the random-access transmission is based on a Slotted ALOHA approach with fast acquisition indication and the UE can start the random-access transmission at the beginning of a number of well-defined time intervals, denoted access slots. There are 15 access slots per two frames. 3GPP Long Term Evolution (LTE) is also considering a Random Access Channel based on access slots.

Currently, any WTRU can equally send a request on one of the Aloha slots regardless of the priority of the data. The information transmitted on the ALOHA slots typically includes control information such as traffic scheduling requests, registration or access messages, or the like but may also include data traffic. For example, assume that a system includes a substantial number of WTRUs that would like to send low priority latency-tolerant traffic, and some WTRUs that would like to send high priority latency-sensitive traffic. Under such a situation, the reservation requests made by the higher priority users on the Slotted Aloha channel may suffer from repeated collisions with the heavily loaded low priority traffic. This results in higher setup (reservation) response times for high priority users, and therefore degrades the performance of such services. Users with different service requirements can be characterized as having different Access Categories (AC), Access Classes, Quality of Service (QoS) classes, or via any other classification indicating varying service requirements.

### SUMMARY

The present invention is related to a method and apparatus for assigning or recommending Aloha slots to WTRUs in a way that can reduce the probability of collisions, and improve the QoS. An AP assigns at least one Aloha slot for a WTRU. The AP may assign the Aloha slot based on quality of service (QoS) policy, measurements of a predetermined metric, or a combination of both. The QoS policy may be related to a priority of the WTRU or a priority of data traffic of the WTRU. The AP may measure the number of WTRUs assigned to each Aloha slot and assign an Aloha slot having the least number of assigned WTRUs. Alternatively, the AP may measure a traffic load on each Aloha slot and assign an Aloha slot with the least traffic load. The AP may also assign an Aloha slot over multiple superframes, where a superframe is the Slotted Aloha period in which there are a given number of slots available for random access, as shown in FIG. 1, (i.e, three superframes are shown in FIG. 1 as an example). The AP may provide an indication of allowed or recommended access categories (ACs) in the Aloha slots. Alternatively, the AP may partition the Aloha slots into a plurality of groups and indicate an AC allowed in each group of Aloha slots. The AP may indicate an access period or frequency for each AC.

### BRIEF DESCRIPTION OF THE DRAWINGS

A more detailed understanding of the invention may be had from the following description of a preferred embodiment, given by way of example and to be understood in conjunction with the accompanying drawing wherein:

FIG. 1 is a block diagram of a plurality of Aloha slots in a slotted-Aloha mechanism;

FIGS. 2-5 are flow diagrams of processes for assigning Aloha slots in accordance with the present invention;

FIG. 6 is a block diagram of an AP configured in accordance with the present invention; and

FIG. 7 is a block diagram of a WTRU configured in accordance with the present invention.

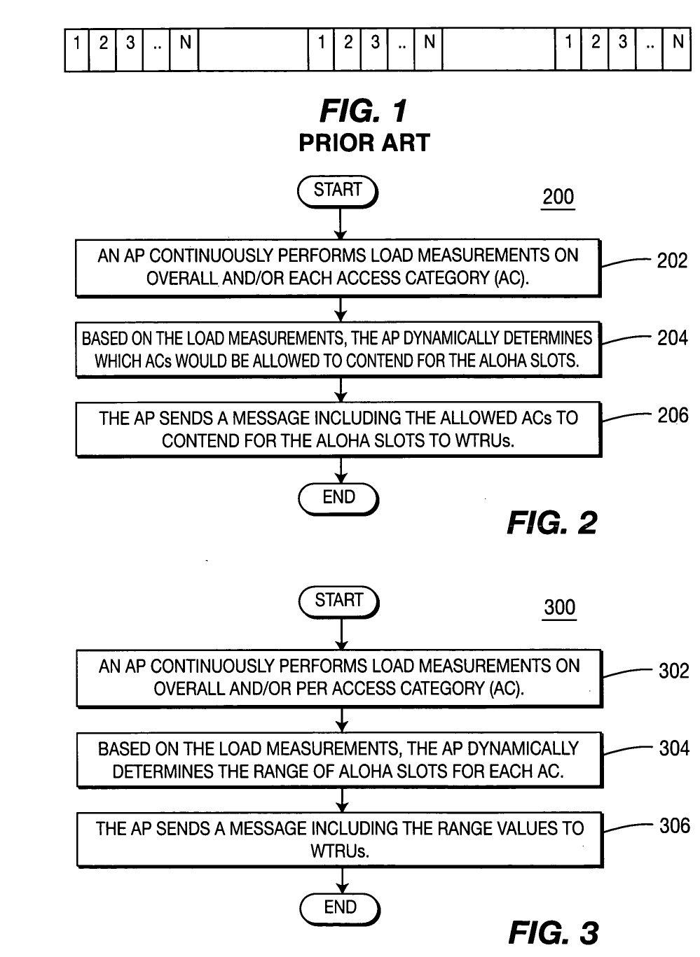

### DETAILED DESCRIPTION OF THE PREFERRED EMBODIMENTS

When referred to hereafter, the terminology “WTRU” includes but is not limited to a user equipment (UE), a mobile station (STA), a fixed or mobile subscriber unit, a pager, or any other type of device capable of operating in a wireless environment. When referred to hereafter, the terminology “AP” includes but is not limited to a Node-B, a base station, a site controller or any other type of interfacing device in a wireless environment.

The features of the present invention may be incorporated into an integrated circuit (IC) or be configured in a circuit comprising a multitude of interconnecting components.

The method and apparatus of the present invention may be applied to any wireless communication system implementing a slotted Aloha-based medium access scheme including, but not limited to, IEEE 802.11 and the 3GPP-based cellular systems.

In accordance with the present invention, the Aloha slots are managed in a quality of service (QoS)-respectful fashion. An AP organizes and assigns (or recommends) to the WTRUs one or more Aloha slots that the WTRUs may use to make an access on. In assigning (or recommending) the Aloha slots, the AP tries to minimize the probability of collision. The AP conducts such assignment, (or recommendation), based on measurements, QoS policies, (e.g., a priority of the WTRU, or a priority of data traffic of the WTRU), or combination thereof.

FIG. 2 is a flow diagram of a process 200 for assigning Aloha slots in accordance with a first embodiment of the present invention. An AP continuously performs load measurements on overall and/or each AC, (i.e., QoS class) (step 202). Four ACs, (best effort, video probe, video and voice), are currently defined in IEEE 802.11 standards. In UMTS, four QoS classes, (conversational, streaming, interactive and background), are currently defined. Based on the load measurements, the AP dynamically determines which ACs would be allowed to contend for the Aloha slots (step 204). For example, if the AP determines only AC=2 or higher may contend for the Aloha slots, a WTRU may only transmit a packet in the Aloha slots for data for AC-2 or higher. The AP then sends a message including the allowed ACs to contend in the Aloha slots to WTRUs (step 206). Alternatively, the AP may determine the allowed ACs based on QoS policies, such as a priority of the WTRU or a priority of data traffic of the WTRU.

The message may be a specific message transmitted by broadcast, multicast or unicast, or may be sent as part of a control message, (e.g., a beacon frame or a broadcast channel). The message may explicitly enumerate all of the permitted ACs. Alternatively, the message may mention one AC and the others can be implied, (e.g., all ACs higher than AC=2 are allowed to access and contend for the Aloha slots).

In accordance with the first embodiment, a higher priority traffic is always given a precedence in accessing the Aloha slots. Irrespective of how high the congestion or load is in the lower priority classes, the lower priority class traffic will never harm the higher priority traffic since the lower priority traffic will not be allowed to contend with the higher priority traffic. For example, a call setup delay, (i.e., the delay to set-up a voice or video call), for conversational traffic can be reduced using this method, due to the lower probability of collision on the access slot.

FIG. 3 is a flow diagram of a process 300 for assigning Aloha slots in accordance with a second embodiment of the present invention. The Aloha slots are partitioned into a plurality of groups. Each group represents a set of Aloha slots that a particular AC (or QoS class) may use to contend. The AP continuously performs load measurements overall and/or per AC (step 302). Based on the load measurements, the AP dynamically determines the group of Aloha slots, (e.g., a starting Aloha slot and an ending Aloha slot), for each AC (or QoS class) (step 304). The AP then sends a message including the range values of the Aloha slots to WTRUs (step 306). Alternatively, the AP may determine the allowed ACs for each group based on QoS policies, such as a priority of the WTRU or a priority of data traffic of the WTRU. The message may be a specific message transmitted by broadcast, multicast or unicast, or may be a control message, (such as a beacon frame or a broadcast channel). In the extremity where a particular AC is to be blocked, a specific value can be used to indicate that the particular AC is blocked, or alternatively, a range value for that particular AC may not be included in the message.

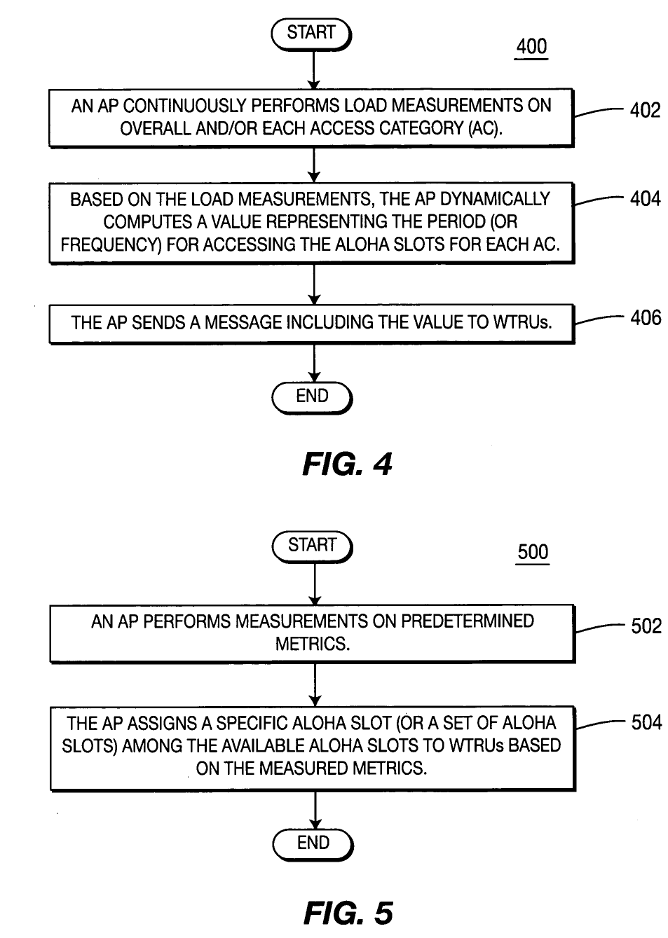

FIG. 4 is a flow diagram of a process 400 for assigning Aloha slots in accordance with a third embodiment of the present invention. A specific access period (or a frequency) to contend or to perform random access is assigned to each AC. The AP continuously performs load measurements overall and/or per AC (step 402). Based on the load measurements, the AP dynamically computes a value representing the access period (or frequency) for accessing the Aloha slots for each AC (step 404). Alternatively, the AP may determine the access period based on QoS policies, such as a priority of the WTRU or a priority of data traffic of the WTRU. The AP then sends a message including the value to WTRUs (step 406). For example, a high priority AC data may be allowed to contend every superframe, (i.e., every slotted-Aloha period), while a lower priority AC data may be allowed to contend only every y-th, (e.g., 2nd or 3rd), superframe, depending on the load measurements. Since lower priority AC data will be allowed to contend less often, the higher priority AC data would benefit from that and their latency due to collisions or contentions is reduced. The message may be a specific message transmitted by broadcast, multicast or unicast, or may be included in a control message, such as a beacon frame or a broadcast channel.

FIG. 5 is a flow diagram of a process 500 for assigning Aloha slots in accordance with a fourth embodiment of the present invention. The AP performs measurements on predetermined metrics, which will be explained in detail hereinafter (step 502). The AP then assigns a specific Aloha slot (or a set of Aloha slots) among the available Aloha slots to WTRUs (step 504). The AP may assign a specific Aloha slot based on QoS policies, such as a priority of WTRU or a priority of data traffic of the WTRU. Since the AP has knowledge of all the WTRUs to whom the AP provides access, (i.e. those WTRUs associated with the AP), the AP may assign the Aloha slots in a way to minimize the probability of collision.

Measurement of the predetermined metrics is explained hereinafter. In accordance with a first option, the AP keeps track of the number of WTRUs that are assigned to each of the Aloha slots. The AP then selects an Aloha slot having the least number of assigned WTRUs. If there is more than one such least-used Aloha slot, the AP may select the Aloha slot randomly, sequentially or in a pre-determined order among the least-used Aloha slots.

In accordance with a second option, the AP keeps track of average (or total) traffic load generated on each Aloha slot, and selects an Aloha slot that has the least traffic load. If there is more than one such least-loaded Aloha slot, the AP may select an Aloha slot among them randomly, sequentially or in a pre-determined order. Even if a WTRU does not generate any traffic on the assigned slot, once a specific slot is assigned to any WTRU, a minimum non-zero load value should be assigned to such Aloha slot in order to differentiate the Aloha slot from a completely free Aloha slot.

The first and second options completely prevent collisions when the number of WTRUs is less than or equal to the number of available Aloha slots. Even if the number of WTRUs is more than the number of Aloha slots, the first and second options significantly reduce collisions because the load will be spread over all of the Aloha slots. The first and second options do not cause any extra latency for transmitting a packet in the Aloha slots.

In the case that the number of WTRUs is more than the number of available Aloha slots, it is possible that more than one WTRU may contend at the same time and collide. In case of collision, a back-off mechanism may be implemented for the subsequent transmission such that the WTRU waits for a randomly selected period before sending the subsequent packet and randomly selects another Aloha slot. Alternatively, a pure random selection may be implemented such that the WTRU may simply select another Aloha slot for the subsequent transmission.

The Aloha slot may be assigned across multiple frames or super-frames, (e.g. multiple 3GPP or IEEE 802.11n periods). For example, if three (3) WTRUs are assigned to the same Aloha slot, each one of three WTRUs may be assigned to an Aloha slot every 3rd superframe in a staggered fashion. This completely prevents collisions and enables the slotted Aloha scheme to scale when there is a large number of WTRUs with respect to the number of available Aloha slots. This option always provides a zero collision probability regardless of the number of WTRUs, but at the expense of latency.

The access slot assignment may be done either prior to the WTRU making its first reservation request or alternatively afterwards. In the prior-to-first-request case, the AP sends a specific message by unicast, multicast or broadcast dedicated for informing the WTRU of its Aloha slot or range of slots. The AP may send such Aloha slot information on other signaling messages, such as a WLAN beacon, 3GPP broadcast messages via a broadcast channel, or one of the messages exchanged during the process of association or registration.

In the after-the-first-request case, the first request that the WTRU makes is done according to the conventional method, (i.e., random selection of the Aloha slot). Once the AP responds to the WTRU through a response message, the AP may include the information on which Aloha slot (or set of slots) the WTRU is assigned or recommended for use.

Alternatively, the WTRU may derive its assigned Aloha slot using another parameter, (or more generally a plurality of parameters (p1, p2, . . . , pk)), that the WTRU knows due to earlier communication. This requires a one-to-one mapping function from the parameters (p1, p2, . . . , pk) to the assigned Aloha slot. For example, the WTRU may use an address, (e.g., WTRU address, MAC address, cell address, or the like), as the parameter.

Alternatively, the WTRU may use a specific function, (e.g., a hashing function), to select an Aloha slot, instead of using a pure random generator as done in the conventional method. If the WTRU may pick an Aloha slot using a specific function, (e.g., a hashing function), that always maps to the same value (as opposed to a random value that always changes), then different WTRUs may always pick different slots since their function's parameters are different and collisions may be reduced. If the outcome of the hashing function is unsatisfactory, (i.e., if repeated collisions are detected by the AP), then another function may be implemented alternatively.

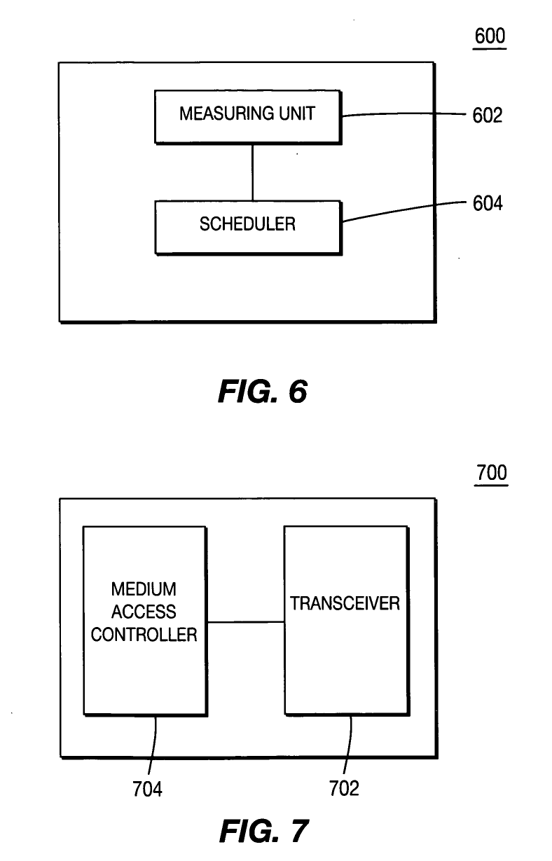

FIG. 6 is a block diagram of an AP 600 in accordance with the present invention. The AP 600 includes a measuring unit 602 and a scheduler 604. The measuring unit 602 is configured to measure and keep track of a predetermined metric with respect to Aloha slots as described hereinbefore. The measuring unit 602 may continuously measure traffic load or track of the number of WTRUs assigned to each AC. The scheduler 604 is configured to send messages to the WTRUs to control transmissions in the Aloha slots based on the measurements, as described hereinbefore. Alternatively, the scheduler 604 may generate the message based on QoS policies, such as a priority of the WTRU or a priority of data traffic of the WTRU.

FIG. 7 is a block diagram of a WTRU 700 configured in accordance with the present invention. The WTRU 700 includes a transceiver 702 and a medium access controller 704. The transceiver 702 is configured to transmit a packet to an AP and receive a message from an AP which assigns at least one Aloha slot for the WTRU 700. The medium access controller 704 is configured to control access to wireless medium in accordance with the present invention such that the WTRU 700 sends a packet on an Aloha slot assigned by the AP.

The medium access controller 704 is configured to determine specific ACs that are allowed to contend for the Aloha slots such that the WTRU 700 may transmit only a packet in the allowed AC in the Aloha slots. The medium access controller 704 is also configured to determine a specific access period for each AC such that the WTRU 700 may transmit a packet via the Aloha slots based on the access period. The packet may be a reservation request packet or a scheduling request packet. Alternatively, the medium access controller 704 may select an Aloha slot randomly for an initial transmission using at least one parameter or a specific function, such as a hashing function.

Although the features and elements of the present invention are described in the preferred embodiments in particular combinations, each feature or element can be used alone without the other features and elements of the preferred embodiments or in various combinations with or without other features and elements of the present invention.

What is claimed is:

1. In a wireless communication system including at least one access point (AP) and at least one wireless transmit/receive unit (WTRU), wherein a WTRU accesses a wireless medium based on a slotted-Aloha mechanism, a method of controlling access to Aloha slots, the method comprising:
an AP sending a message to a WTRU to assign at least one Aloha slot for the WTRU; and
the WTRU sending a packet on the assigned Aloha slot.

2. The method of claim 1 wherein the AP assigns the Aloha slot based on quality of service (QoS) policy.

3. The method of claim 1 wherein the AP assigns the Aloha slot based on a priority of the WTRU.

4. The method of claim 1 wherein the AP assigns the Aloha slot based on a priority of data traffic of the WTRU.

5. The method of claim 1 further comprising:
measuring a predetermined metric, whereby the AP assigns the Aloha slot based on the measurements.

6. The method of claim 5 wherein the predetermined metric is the number of WTRUs assigned to each of the Aloha slots, and the AP selects the specific Aloha slot with the least number of assigned WTRUs.

7. The method of claim 6 wherein if there is more than one Aloha slot with the least number of assigned WTRUs, the AP selects the specific Aloha slot randomly among the Aloha slots with the least number of assigned WTRUs.

8. The method of claim 6 wherein if there is more than one Aloha slot with the least number of assigned WTRUs, the AP selects the specific Aloha slot in a predetermined order among the Aloha slots with the least number of assigned WTRUs.

9. The method of claim 5 wherein the predetermined metric is a traffic load on each of the Aloha slots, and the AP selects the specific Aloha slot with the least traffic load.

10. The method of claim 9 wherein the AP assigns a minimum non-zero value to an Aloha slot that has been assigned but does not generate any traffic in selecting the Aloha slot.

11. The method of claim 9 wherein if there is more than one Aloha slot with the least traffic load, the AP selects the specific Aloha slot randomly among the Aloha slots with the least traffic load.

12. The method of claim 9 wherein if there is more than one Aloha slot with the least traffic load, the AP selects the specific Aloha slot in a predetermined order among the Aloha slots with the least traffic load.

13. The method of claim 1 wherein the AP assigns the specific Aloha slot over multiple superframes.

14. The method of claim 1 wherein the AP restricts specific access categories (ACs) that are allowed to contend for the Aloha slots, wherein the WTRU may transmit only a packet in the allowed AC in the Aloha slots.

15. The method of claim 14 wherein the AP restricts specific ACs based on at least one of quality of service (QoS) policy and measurements of a predetermined metric.

16. The method of claim 14 wherein the AP partitions the Aloha slots into a plurality of groups and restricts a specific AC allowed in each of the groups of Aloha slots.

17. The method of claim 14 wherein the AP specifically enumerates the allowed ACs.

18. The method of claim 14 wherein the AP indicates the lowest AC that is allowed to contend in the Aloha slots, whereby any AC that is equal to or higher than the lowest AC may be transmitted in the Aloha slots.

19. The method of claim 1 wherein the AP assigns specific access periods for each of access category (AC), whereby the WTRU may transmit a packet via the Aloha slots based on the access period.

20. The method of claim 1 wherein the AP sends the message via one of a beacon frame and a broadcast channel.

21. The method of claim 1 wherein the packet is a reservation request packet.

22. The method of claim 1 wherein the packet is a scheduling request packet.

23. The method of claim 1 wherein the wireless communication system is an IEEE 802.11n system.

24. The method of claim 1 wherein the wireless communication system is a third generation partnership project (3GPP)-based cellular system.

25. The method of claim 1 wherein the AP sends the message after receiving an initial transmission from the WTRU.

26. The method of claim 25 wherein the WTRU selects an Aloha slot for the initial transmission randomly.

27. The method of claim 25 wherein the WTRU selects an Aloha slot using at least one parameter.

28. The method of claim 25 wherein the WTRU selects an Aloha slot using a specific function.

29. The method of claim 28 wherein the function is a hashing function.

30. In a wireless communication system implementing a slotted-Aloha mechanism for wireless medium access, an access point (AP) for controlling access to Aloha slots, the AP comprising:
a scheduler configured to send a message to a wireless transmit/receive unit (WTRU) to assign at least one Aloha slot for the WTRU, whereby the WTRU sends a packet on the assigned Aloha slot.

31. The AP of claim 30 wherein the scheduler assigns the Aloha slot based on quality of service (QoS) policy.

32. The AP of claim 30 wherein the scheduler assigns the Aloha slot based on a priority of the WTRU.

33. The AP of claim 30 wherein the scheduler assigns the Aloha slot based on a priority of data traffic of the WTRU.

34. The AP of claim 30 further comprising:
a measurement unit for measuring a predetermined metric, whereby the scheduler assigns the Aloha slot based on the measurements.

35. The AP of claim 34 wherein the predetermined metric is the number of WTRUs assigned to each of the Aloha slots, and the scheduler selects the specific Aloha slot with the least number of assigned WTRUs.

36. The AP of claim 35 wherein if there is more than one Aloha slot with the least number of assigned WTRUs, the scheduler selects the specific Aloha slot randomly among the Aloha slots with the least number of assigned WTRUs.

37. The AP of claim 35 wherein if there is more than one Aloha slot with the least number of assigned WTRUs, the scheduler selects the specific Aloha slot in a predetermined order among the Aloha slots with the least number of assigned WTRUs.

38. The AP of claim 34 wherein the predetermined metric is a traffic load on each of the Aloha slots, and the scheduler selects the specific Aloha slot with the least traffic load.

39. The AP of claim 38 wherein the scheduler assigns a minimum non-zero value to an Aloha slot that has been assigned but does not generate any traffic in evaluating the metric.

40. The AP of claim 38 wherein if there is more than one Aloha slot with the least traffic load, the scheduler selects the specific Aloha slot randomly among the Aloha slots with the least traffic load.

41. The AP of claim 38 wherein if there is more than one Aloha slot with the least traffic load, the scheduler selects the specific Aloha slot in a predetermined order among the Aloha slots with the least traffic load.

42. The AP of claim 30 wherein the scheduler assigns the specific Aloha slot over multiple superframes.

43. The AP of claim 30 wherein the scheduler restricts specific access categories (ACs) that are allowed to contend for the Aloha slots, whereby the WTRU may transmit only a packet in an allowed AC in the Aloha slots.

44. The AP of claim 43 wherein the AP restricts the specific ACs based on at least one of quality of service (QoS) policy and measurements of a predetermined metric.

45. The AP of claim 43 wherein the scheduler partitions the Aloha slots into a plurality of groups and indicates an AC allowed in each of the groups of Aloha slots in the message.

46. The AP of claim 43 wherein the scheduler enumerates allowed ACs in the message.

47. The AP of claim 43 wherein the scheduler indicates the lowest AC that are allowed to content in the Aloha slots in the message, whereby any AC that is equal to or higher than the lowest AC may be transmitted in the Aloha slots.

48. The AP of claim 30 wherein the scheduler assigns an access period for each access category (AC), whereby the WTRU may transmit the packet based on the access period.

49. The AP of claim 30 wherein the scheduler includes the message in one of a beacon frame and a broadcast channel message.

50. The AP of claim 30 wherein the packet is a reservation request packet.

51. The AP of claim 30 wherein the packet is a scheduling request packet.

52. The AP of claim 30 wherein the wireless communication system is an IEEE 802.11n system.

53. The AP of claim 30 wherein the wireless communication system is a third generation partnership project (3GPP)-based cellular system.

54. The AP of claim 30 wherein the scheduler sends the message after receiving an initial transmission from the WTRU.

55. The AP of claim 54 wherein the WTRU selects an Aloha slot for the initial transmission randomly.

56. The AP of claim 54 wherein the WTRU selects an Aloha slot using at least one parameter.

57. The AP of claim 54 wherein the WTRU selects an Aloha slot using a specific function.

58. The AP of claim 57 wherein the function is a hashing function.

59. In a wireless communication system implementing a slotted-Aloha mechanism for wireless medium access, a wireless transmit/receive unit (WTRU) comprising:
a transceiver configured to transmit a packet and receive a message from an access point (AP) which assigns at least one Aloha slot for the WTRU; and
a medium access controller configured to control access to a wireless medium such that the WTRU sends a packet on the assigned Aloha slot.

60. The WTRU of claim 59 wherein the medium access controller is configured to determine specific access categories (ACs) that are allowed to contend for the Aloha slots, whereby the WTRU may transmit only a packet in an allowed AC in the Aloha slots.

61. The WTRU of claim 59 wherein the medium access controller is configured to determine a specific access period for each of access categories (ACs), whereby the WTRU may transmit a packet via the Aloha slots based on the access period.

62. The WTRU of claim 59 wherein the packet is a reservation request packet.

63. The WTRU of claim 59 wherein the packet is a scheduling request packet.

64. The WTRU of claim 59 wherein the medium access controller is configured to select an Aloha slot randomly for an initial transmission.

65. The WTRU of claim 64 wherein the medium access controller selects an Aloha slot using at least one parameter.

66. The WTRU of claim 64 wherein the medium access controller selects an Aloha slot using a specific function.

67. The WTRU of claim 66 wherein the function is a hashing function.
